(19) United States
(12) Patent Application Publication
(10) Pub. No.: US 2023/0070245 A1
(43) Pub. Date: Mar. 9, 2023

(54) ELECTRIC VESSEL ADOPTING ELECTRIFIED COMPONENTS FOR VEHICLE AND METHOD OF CONTROLLING THE SAME

(71) Applicant: HYUNDAI MOBIS Co., Ltd., Seoul (KR)

(72) Inventor: Chang Hoon LEE, Seoul (KR)

(73) Assignee: HYUNDAI MOBIS Co., Ltd., Seoul (KR)

(21) Appl. No.: 17/903,097

(22) Filed: Sep. 6, 2022

(30) Foreign Application Priority Data
Sep. 8, 2021 (KR) 10-2021-0120042

(51) Int. Cl. B63H 21/21; G05D 1/02; B63H 21/17; G08G 3/02; B63B 79/10; B63B 79/40

(52) U.S. Cl. CPC B63H 21/21; G05D 1/0206; B63H 21/17; G08G 3/02; B63B 79/10; B63B 79/40; B63H 2021/173; B63H 2021/216; G01S 13/937

(57) ABSTRACT

An electric vessel includes a drive motor to rotate a propeller; a battery module to supply a voltage; an inverter to convert a DC voltage of the battery module into an AC voltage to drive the drive motor; a battery management system (BMS); an electronic control unit (ECU) including a vessel control unit to control the BMS, the inverter, and the drive motor in order to operate the vessel; and an operation unit to transmit an operation signal to the ECU according to a driver's operation.

### CROSS-REFERENCE TO RELATED APPLICATION

This application claims priority to and the benefit of Korean Patent Application No. 10-2021-0120042, filed on Sep. 8, 2021, the disclosure of which is incorporated herein by reference in its entirety.

### BACKGROUND

### 1. Field of the Invention

The present invention relates to an electric vessel, and more specifically, to a vessel electrified by adopting electrified components for a vehicle and a method of controlling the same.

### 2. Discussion of Related Art

Electrified components of an electric vehicle include schematically an electronic control unit (ECU), a battery management system (BMS), a battery, an inverter, and a drive motor. Conventionally, electric vehicles have been designed with a concept of applying electrified components to conventional internal combustion engine vehicles, but recently, an electric vehicle-dedicated platform (e.g., an electric-global modular platform (E-GMP) of Hyundai Motor Company in Korea) has been developed and used to electrify various vehicle models.

Electric vessels that have electrified vessels are not currently actually implemented and may not be easily implemented using conventional motors and batteries either. The reason is that conventional electric drive systems simply using a motor and a battery have extremely low operation efficiency of the vessel and have low performance of the motor and the battery, and thus there is a problem such as a degradation of durability or an excessive load.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

The present invention is directed to reducing development costs and maximizing energy efficiency of an electric vessel by adopting electrified components for a vehicle to manufacture a propellant of the electric vessel.

One aspect of the present invention for achieving the object provides an electric vessel using electrified components for a vehicle. A development concept of the electric vessel is to implement a propulsion system of the electric vessel by using or sharing a battery, a battery management system (BMS), an inverter, and a drive motor of an electrified vehicle.

The electric vessel implemented with the electrified components for the vehicle rotates a propeller with at least one drive motor, and applies power to the drive motor through an inverter from a battery module to which several battery cells are connected. A control is performed by adjusting an amount of power that moves from the battery module to the drive motor by a driver's operation of a steering device such as a lever or a rudder.

In order to implement the electric vessel according to the present invention, it is possible to adopt not only conventional electrified components for the vehicle, but also a battery platform technique for an electric vehicle (e.g., E-GMP) that is the latest technique. In particular, since an operation frequency is lower than an operation frequency of a vehicle due to the characteristics of the vessel (about ⅙ or less), an electronic control unit (ECU), the BMS, the inverter, and the like for the vehicle may be designed to be scaled down and applied to the vessel.

In one general aspect, an electric vessel includes: a drive motor configured to rotate a propeller; a battery module configured to supply a voltage; an inverter configured to convert a DC voltage of the battery module into an AC voltage to drive the drive motor; a battery management system (BMS); an electronic control unit (ECU) including a vessel control unit configured to control the BMS, the inverter, and the drive motor in order to operate the vessel; and an operation unit configured to transmit an operation signal to the ECU according to a driver's operation.

The electric vessel may include a solar module configured to send solar energy to one or both of the battery module and the BMS.

At least one of the drive motor, the battery module, the inverter, and the BMS may be included in an electrified platform for an electric vehicle.

The battery module may include a 5C-rate battery.

The battery module may include a high-voltage battery for driving the motor and a low-voltage battery for electrical devices in the vessel.

The electric vessel may include a converter configured to convert a voltage of the battery module into a different voltage and output the different voltage as power for external devices.

The ECU may include: a radar control unit configured to receive radar information from a radar system installed on a hull, process the radar information to generate a radar control signal, and transmit the radar control signal to the radar system; a semi-autonomous traveling unit configured to generate a control signal for semi-autonomous traveling in a form in which manual traveling under a driver's control and fully autonomous traveling in which driver intervention is excluded are combined; and a collision prevention unit configured to detect obstacles using an obstacle detection sensor.

The vessel control unit of the ECU may be configured to execute: a lock mode that is entered by turning off an ignition key to cut off a function of the vessel; an emergency mode in which an output of the battery module supplied to the motor is cut off; and an anchorage mode that is manually entered when the vessel is not used to cut off the output of the battery module.

The ECU may include: a secondary heat sink attached to a printed circuit board (PCB) to dissipate heat from heat-generation elements mounted on the PCB; and a main heat sink contacting the secondary heat sink to dissipate heat from the ECU.

An operation frequency domain of the drive motor, the battery module, the inverter, the BMS, and the ECU may range from 0 to 1500 Hz.

A method of controlling the electric vessel may include transmitting an operation signal including a force and a change amount generated by a driver operation of a steering device from the operation unit to the ECU; converting the received operation signal into a control signal including a controlled variable for controlling the drive motor, and transmitting the control signal to the inverter by the ECU; modulating a voltage of the battery module so that the controlled variable is reflected according to the control signal from the ECU to generate drive power, and applying the drive power to the drive motor by the inverter; and giving propulsion to the vessel by rotating the propeller by the drive motor.

The method may include converting the voltage of the battery module into a different voltage, and outputting the different voltage as power for external devices.

The method may include converting the voltage of the battery module into a different voltage, and outputting the different voltage as power for external devices.

The method of may include: by the ECU, receiving radar information from a radar system installed on a hull, processing the radar information to generate a radar control signal, and transmitting the radar control signal to the radar system; generating a control signal for semi-autonomous traveling in a form in which manual traveling under a driver's control and fully autonomous traveling in which driver intervention is excluded are combined; and detecting obstacles using an obstacle detection sensor to prevent a collision.

The operation signal may be transmitted to the ECU using one of controller area network (CAN) communication and wired communication.

The control signal may be transmitted to the inverter using one of controller area network (CAN) communication and wired communication.

Another feature of the present invention provides a method of controlling an electric vessel having the above characteristics.

The present invention introduced as described above will become clearer through specific embodiments to be described below in conjunction with the drawings.

Other features and aspects will be apparent from the following detailed description, the drawings, and the claims.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a schematic configuration diagram of an electric vessel according to the present invention;

FIG. 2 is a signal flow diagram for describing an operation of the electric vessel according to the present invention;

FIG. 3 is a detailed configuration diagram of an electronic control unit (ECU); and

FIG. 4 is a view showing a structure of a heat sink for dissipating heat generated from the ECU.

### DETAILED DESCRIPTION

Advantages and features of the present invention, and methods of achieving them will become apparent with reference to the detailed description in conjunction with the accompanying drawings. However, the present invention is not limited to the embodiments disclosed below but will be implemented in various different forms, and only these embodiments are provided so that the disclosure of the present invention will be thorough and complete and will fully convey the scope of the invention to those skilled in the art to which the present invention pertains, and the present invention is defined by the description of the claims. Meanwhile, the terms used herein are for the purpose of describing the embodiments, and are not intended to limit the present invention. In this specification, the singular form also includes the plural form unless specifically stated otherwise in the phrase. As used herein, ‘comprise’ or ‘comprising’ does not preclude the presence or addition of one or more other components, steps, operations, and/or elements other than the stated components, steps, operations, and/or elements.

Hereinafter, exemplary embodiments of the present invention will be described in detail with reference to the accompanying drawings. In adding reference numerals to the components of each drawing, the same components are given the same reference numerals as much as possible even though they are indicated on different drawings, and in addition, in describing the present invention, when a detailed description of a related known configuration or function may obscure the gist of the present invention, the detailed description thereof will be omitted.

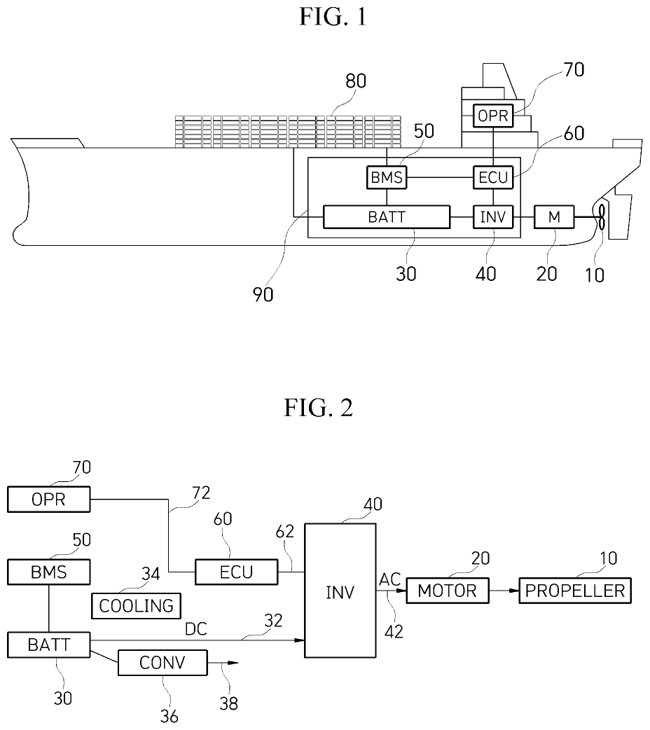

FIG. 1 is a schematic configuration diagram of an electric vessel according to the present invention, and particularly shows a propellant of the vessel implemented with electrified components for a vehicle.

The electric vessel includes: a drive motor 20 configured to rotate a propeller 10; a battery module 30 as a voltage supply source; an inverter 40 configured to convert a DC voltage of the battery module 30 into an AC voltage to drive the drive motor 20; a battery management system (BMS) 50; an electronic control unit (ECU) 60 configured to control the BMS 50, the inverter 40, and the drive motor 20; and an operation unit 70 configured to transmit an operation signal to the ECU 60 according to a driver's operation of a lever or a rudder. In addition, the electric vessel further includes a solar module 80 installed on a deck of the electric vessel to supply energy to the battery module 30 and/or the BMS 50.

The above components may be implemented with individual electrified components used in electric vehicles, but an electrified platform for an electric vehicle (e.g., E-GMP) in which a cooling device is integrated may also be used. As a result, development costs for the electric vessel are reduced, and energy efficiency of the electric vessel is maximized by using a verified electrified component or platform. In particular, since the electrified platform for the electric vehicle tends to be made of a lithium material other than iron phosphate, which is a pollutant, the electrified platform is particularly suitable for an eco-friendly policy.

There are things to consider in order to apply the electrified components for the vehicle to the electric vessel.

In the case of the electric vehicle, voltage information of an accelerator pedal sensor, which generates controlled variables for driving the drive motor configured to rotate wheels, should be converted into a frequency domain and applied to the inverter, and at this time, the frequency domain is generally 0 to 8 kHz (=8000 Hz).

However, in the case of the electric vessel, a frequency domain required by the inverter is 0 to 1500 Hz, and is much smaller than that of the electric vehicle. Accordingly, in the case of the electric vessel, an operation frequency domain of all electrified components and related elements should be designed differently from those for the electric vehicle. In addition, all required components including the ECU, the inverter, the BMS, and the like may be designed to be scaled down due to this relatively low frequency, so that it is possible to obtain benefits such as reducing the cost, shortening development/manufacturing periods, and reducing the weight.

FIG. 2 is a configuration diagram and a signal flow diagram for describing an operation and control of the electric vessel according to the present invention.

First, a drive signal 72 including a force and a change amount generated by a driver's operation of a steering device such as a lever or a rudder is transmitted from the operation unit 70 to the ECU 60. At this time, controller area network (CAN) communication may be used, but wired communication through a wire may also be used.

The ECU 60 converts the received operation signal 72 into a control signal 62 including controlled variables for controlling the drive motor 20 of the propeller and transmits the control signal 62 to the inverter 40. Even at this time, the CAN communication may also be used. However, as described above, the wired communication through the wire may also be used.

The inverter 40 functions to receive a DC voltage of the battery module 30 and convert the DC voltage into an AC voltage for driving the drive motor 20. In other words, the inverter 40 modulates a battery voltage 32 with the control variable according to the control signal 62 from the ECU 60 to generate drive power 42, and applies the generated drive power 42 to the drive motor 20.

The drive motor 20 gives propulsion to the vessel by rotating the propeller 10. Although not shown in FIG. 2, a power transmission device such as a reduction gear may be actually positioned between the drive motor 20 and the propeller 10.

The BMS 50 shown in FIG. 2 functions to manage the battery module 30, and a cooling device 34 functions to cool the battery module 30. In addition, the solar module 80 shown in FIG. 1 continuously sends collected energy to the BMS 50 (or the battery module 30) to reinforce the energy. In addition, an output voltage of the battery module 30 also enters the converter 36, is converted into a voltage different from the voltage of the battery module 30, and is output as external device power 38. The external device power 38 is a voltage required for external devices (TV, communication device, cooking machine, and other devices for life on the vessel) other than driving the vessel. In the case of the vessel, the role of the converter 36 may be more important because a crew member has a longer residence time than that of the vehicle and needs to eat and sleep.

The battery module 30 may include a high-voltage battery for a motor having an output of about 700 Vdc and a low-voltage battery for an electronic component having an output of about 24 Vdc. However, the BMS 50 may also appropriately operate one battery to distribute the battery as voltages for the motor and the electronic component.

Meanwhile, in the case of the electric vessel, since a speed of about 20 knots is required even for a relatively small-scale leisure boat, a battery capacity should be greater than that of the vehicle. For example, a 4C-rate battery is generally used for the electric vehicle whereas a 5C-rate battery greater than the 4C-rate battery is used for the electric vessel.

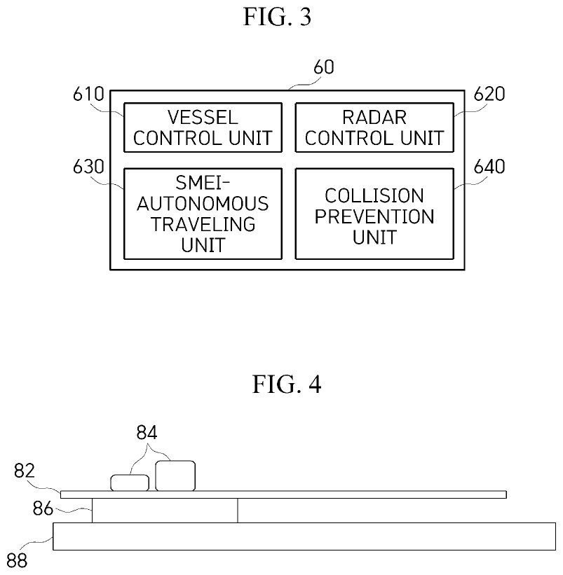

FIG. 3 is a detailed configuration diagram of the ECU 60.

In addition to an operation control unit 610 of the electric vessel using the electrified components, the ECU 60 includes a radar control unit 620, a semi-autonomous traveling unit 630, and a collision prevention unit 640, which are required for a safe operation of the vessel.

The radar control unit 620 may receive radar information from a radar system installed on a hull, process the radar information to generate a radar control signal, and transmit the radar control signal to the radar system.

The semi-autonomous traveling unit 630 may generate a control signal for semi-autonomous traveling in a form in which manual traveling under a driver's control and fully autonomous traveling in which driver intervention is excluded are combined in connection with the operation unit 70. To this end, various sensors, mechanical elements, and autonomous traveling algorithms may be used.

The collision prevention unit 640 may also include only a function of detecting and alerting other vessels, reefs, cliffs, and the like using various obstacle detection sensors and radar systems, and also include a function of automatically avoiding the hull when a hull collision is expected in connection with the semi-autonomous traveling unit 630 together.

As described above, since the electric vessel should have a battery capacity greater than that of the electric vehicle and a throughput of the ECU 60 is greater than that of the electric vehicle, an amount of heat generated from the ECU 60 increases, and thus solutions thereto should be pursued.

FIG. 4 shows a structure of a heat sink for effectively dissipating heat generated from the ECU 60.

The heat sink includes a secondary heat sink 86 attached to the other surface of a printed circuit board (PCB) 82 for dissipating heat from heat-generation elements 84 such as a field-effect transistor (FET), a motor driver, etc. mounted on one surface of the PCB 82, and a main heat sink 88 coming into contact with the secondary heat sink 86 and exposed to external environments to function to dissipate heat from the overall ECU system.

In addition to the heat sink in FIG. 4, a blowing device (not shown) such as a cooling fan or blower may also be adopted as a heat dissipation unit for concentrated heat dissipation of a specific high heat-generation module.

Operation modes of the electric vessel configured as described above will be described in more detail. The operation modes of the electric vessel according to the present invention may largely include a lock (power-off) mode, a charging mode, a start mode, a normal output mode, an emergency mode, and an anchorage mode. Each mode will be described.

The lock mode is a power-off mode of the vessel, and is entered by turning off an ignition key. At this time, all functions except for components for operations of a space heater configured to prevent condensation of the motor included in the motor 20, a low-voltage battery configured to turn on the space heater, a bilge pump configured to drain gray water, and an ignition key security module are cut off.

The charging mode is entered upon plug-in of a charger. Since the charging mode is substantially similar to that of the vehicle, a detailed description thereof will be omitted.

The start mode is entered when the ignition key goes to an On position through an Acc position. First, when the driver puts the ignition key to the Acc position, the low-voltage battery starts supplying power to other low-voltage electrical devices in a state of still supplying a voltage to the motor space heater. However, a power-off signal to the inverter and the converter is maintained. Next, when the driver moves the ignition key to the On position, power is supplied to the motor to operate, and the motor space heater, which is no longer needed, is turned off. In addition, a power-on signal is applied to the inverter and the converter.

The normal output mode is a mode in which power is normally supplied after the start mode, and is substantially similar to that of the vehicle, and thus a detailed description thereof will be omitted.

The emergency mode is entered when an emergency switch is operated or an off-gas alarm is triggered, and in other emergency situations. In the emergency mode, an output of the high-voltage battery is cut off and the driving of the electric vessel is stopped.

The anchorage mode may be entered manually when the vessel is not used for a long time. When the anchorage mode is entered, outputs of all batteries are cut off.

According to the present invention, it is possible to improve functionality and efficiency of previously developed components, improve safety of the vessel, shorten a development period, reduce a cost, and obtain an eco-friendliness effect by adopting electrified components of a vehicle to an electric vessel as part of a current de-carbonization new deal policy.

Although the configuration of the present invention has been described above in detail through the exemplary embodiments of the present invention, those skilled in the art to which the present invention pertains will be able to understand that the present invention may be implemented in a specific form different from the contents disclosed in this specification without changing the technical spirit or essential features of the present invention. It should be understood that the above-described embodiments are illustrative and not restrictive in all respects. The scope of the present invention is defined by the claims described below rather than the detailed description, and all changed or modified examples derived from the claims and their equivalent concepts should be construed as being included in the technical scope of the present invention.

What is claimed is:

1. An electric vessel, comprising:
a drive motor configured to rotate a propeller;
a battery module configured to supply a voltage;
an inverter configured to convert a DC voltage of the battery module into an AC voltage to drive the drive motor;
a battery management system (BMS);
an electronic control unit (ECU) including a vessel control unit configured to control the BMS, the inverter, and the drive motor in order to operate the vessel; and
an operation unit configured to transmit an operation signal to the ECU according to a driver's operation.

2. The electric vessel of claim 1, further comprising a solar module configured to send solar energy to one or both of the battery module and the BMS.

3. The electric vessel of claim 1, wherein at least one of the drive motor, the battery module, the inverter, and the BMS is included in an electrified platform for an electric vehicle.

4. The electric vessel of claim 1, wherein the battery module includes a 5C-rate battery.

5. The electric vessel of claim 1, wherein the battery module includes a high-voltage battery for driving the motor and a low-voltage battery for electrical devices in the vessel.

6. The electric vessel of claim 1, further comprising a converter configured to convert a voltage of the battery module into a different voltage and output the different voltage as power for external devices.

7. The electric vessel of claim 1, wherein the ECU further includes:
a radar control unit configured to receive radar information from a radar system installed on a hull, process the radar information to generate a radar control signal, and transmit the radar control signal to the radar system;
a semi-autonomous traveling unit configured to generate a control signal for semi-autonomous traveling in a form in which manual traveling under a driver's control and fully autonomous traveling in which driver intervention is excluded are combined; and
a collision prevention unit configured to detect obstacles using an obstacle detection sensor.

8. The electric vessel of claim 1, wherein the vessel control unit of the ECU is configured to execute:
a lock mode that is entered by turning off an ignition key to cut off a function of the vessel;
an emergency mode in which an output of the battery module supplied to the motor is cut off; and
an anchorage mode that is manually entered when the vessel is not used to cut off the output of the battery module.

9. The electric vessel of claim 1, wherein the ECU includes:
a secondary heat sink attached to a printed circuit board (PCB) to dissipate heat from heat-generation elements mounted on the PCB; and
a main heat sink contacting the secondary heat sink to dissipate heat from the ECU.

10. The electric vessel of claim 1, wherein an operation frequency domain of the drive motor, the battery module, the inverter, the BMS, and the ECU ranges from 0 to 1500 Hz.

11. A method of controlling the electric vessel of claim 1, the method comprising:
transmitting an operation signal including a force and a change amount generated by a driver operation of a steering device from the operation unit to the ECU;
converting the received operation signal into a control signal including a controlled variable for controlling the drive motor, and transmitting the control signal to the inverter by the ECU;
modulating a voltage of the battery module so that the controlled variable is reflected according to the control signal from the ECU to generate drive power, and applying the drive power to the drive motor by the inverter; and
giving propulsion to the vessel by rotating the propeller by the drive motor.

12. The method of claim 11, wherein at least one of the drive motor, the battery module, the inverter, and the BMS is included in an electrified platform for an electric vehicle.

13. The method of claim 11, further comprising converting the voltage of the battery module into a different voltage, and outputting the different voltage as power for external devices.

14. The method of claim 11, further comprising: by the ECU, receiving radar information from a radar system installed on a hull, processing the radar information to generate a radar control signal, and transmitting the radar control signal to the radar system;
generating a control signal for semi-autonomous traveling in a form in which manual traveling under a driver's control and fully autonomous traveling in which driver intervention is excluded are combined; and
detecting obstacles using an obstacle detection sensor to prevent a collision.

15. The method of claim 11, wherein the ECU executes:
a lock mode that is entered by turning off an ignition key to cut off a function of the vessel;
an emergency mode in which an output of the battery module supplied to the motor is cut off; and
an anchorage mode that is manually entered when the vessel is not used to cut off the output of the battery module.

16. The method of claim 11, wherein the operation signal is transmitted to the ECU using one of controller area network (CAN) communication and wired communication.

17. The method of claim 11, wherein the control signal is transmitted to the inverter using one of controller area network (CAN) communication and wired communication.
